(19) United States
(12) Patent Application Publication
(10) Pub. No.: US 2025/0328808 A1
(43) Pub. Date: Oct. 23, 2025

(54) CONTRIBUTION DATA CALIBRATION

(71) Applicant: ADOBE INC., SAN JOSE, CA (US)

(72) Inventors: Bei Huang, Mountain View, CA (US); Yuan Yuan, Sunnyvale, CA (US); Yiming Xu, Sunnyvale, CA (US); Qilong Yuan, San Jose, CA (US); Jin Xu, Sunnyvale, CA (US); Lijing Wang, Menlo Park, CA (US); Bowen Wang, Milpitas, CA (US); Yancheng Li, Santa Clara, CA (US); Zhenyu Yan, Cupertino, CA (US)

(21) Appl. No.: 18/637,718

(22) Filed: Apr. 17, 2024

(51) Int. Cl. G06N 20/00

(52) U.S. Cl. CPC G06N 20/00

(57) ABSTRACT

A method, non-transitory computer readable medium, apparatus, and system for data processing include obtaining, by a multi-touch attribution model, individual-level user interaction data from a digital content channel, and computing, using the multi-touch attribution model, channel contribution data based on the individual-level user interaction data. Some embodiments include training, using a training component, an aggregate attribution model based on the channel contribution data. Some embodiments include generating, using a calibration component, an individual channel contribution value for the digital content channel based on the channel contribution data and the aggregate attribution model.

### BACKGROUND

The following relates generally to data processing, and more specifically to contribution data calibration. Data processing refers to a processing of input data to generate meaningful output data through various operations and transformations. In some cases, data processing includes manipulating, organizing, analyzing, and/or interpreting data to extract insights, make decisions, and achieve specific objectives.

In some cases, data processing includes processing input data to determine a relative effect that one or more events included in the input data has on an occurrence of an outcome event. In some cases, output data that is generated based on such processing is referred to as contribution data.

In some cases, the events in the input data are explicitly related to one or more particular users, allowing the contribution data to also be computed for a particular user. However, conventional data processing systems do not accurately account for an effect that aggregate, non-user-attributable data has on an occurrence of an outcome event, and therefore provide relatively inaccurate contribution data. There is therefore a need in the art for data processing systems and methods that generate accurate contribution data.

### SUMMARY

Embodiments of the present disclosure provide a data processing system and apparatus for computing, using a multi-touch attribution machine learning model, channel contribution data based on individual-level user interaction data from a digital content channel, training an aggregate attribution machine learning model based on the channel contribution data, and generating an individual channel contribution value for the digital content channel based on the channel contribution data and the aggregate attribution machine learning model.

Accordingly, in some cases, by training the aggregate attribution machine learning model based on the output of the multi-touch attribution machine learning model, the aggregate attribution machine learning model learns to provide an output based on both aggregate, non-user-attributable data and knowledge provided by a machine learning model that processes user-attributable interaction data, such that the output of the aggregate attribution machine learning model is compatible with the channel contribution data.

Therefore, by generating the individual channel contribution value for the digital content channel based on the channel contribution data and the aggregate attribution machine learning model, the data processing system and apparatus provide contribution data that is calibrated based on both user-attributable interaction data and aggregate, non-user-attributable data, and is therefore more accurate than conventional contribution data provided by conventional data processing systems and methods.

A method, apparatus, non-transitory computer readable medium, and system for data processing are described. One or more aspects of the method, apparatus, non-transitory computer readable medium, and system include obtaining individual-level user interaction data from a digital content channel; computing channel contribution data based on the individual-level user interaction data; training an aggregate attribution model based on the channel contribution data; and generating an individual channel contribution value for the digital content channel based on the channel contribution data and the aggregate attribution model.

A method, apparatus, non-transitory computer readable medium, and system for data processing are described. One or more aspects of the method, apparatus, non-transitory computer readable medium, and system include obtaining individual-level user interaction data for a user from a digital content channel; computing an individual channel contribution value based on the individual-level user interaction data; updating the individual channel contribution value based on an aggregate attribution model to obtain an updated channel contribution value; and providing customized content to the user via the digital content channel based on the updated channel contribution value.

An apparatus and system for data processing are described. One or more aspects of the apparatus and system include at least one memory; at least one processor executing instructions stored in the at least one memory; a multi-touch attribution model comprising multi-touch attribution parameters stored in the at least one memory, the multi-touch attribution model trained to compute channel contribution data based on individual-level user interaction data from a digital content channel; an aggregate attribution model comprising aggregate attribution parameters stored in the at least one memory, the aggregate attribution model trained to compute an aggregate channel contribution value for the digital content channel; and a calibration component configured to generate an individual channel contribution value for the digital content channel based on the channel contribution data and the aggregate channel contribution value.

### BRIEF DESCRIPTION OF THE DRAWINGS

FIG. 1 shows an example of a data processing system according to aspects of the present disclosure.

FIG. 2 shows an example of a data processing apparatus according to aspects of the present disclosure.

FIG. 3 shows an example of data processing apparatus layers according to aspects of the present disclosure.

FIG. 4 shows an example of a method for generating a content distribution campaign according to aspects of the present disclosure.

FIG. 5 shows an example of a method for data processing according to aspects of the present disclosure.

FIG. 6 shows an example of training an aggregate attribution model according to aspects of the present disclosure.

FIG. 7 shows an example of a method for updating parameters of an aggregate attribution model according to aspects of the present disclosure.

FIG. 8 shows an example of a method for providing customized content according to aspects of the present disclosure.

### DETAILED DESCRIPTION

Data processing refers to a processing of input data to generate meaningful output data through various operations and transformations. In some cases, data processing includes manipulating, organizing, analyzing, and/or interpreting data to extract insights, make decisions, and achieve specific objectives. In some cases, data processing includes processing input data to determine a relative effect that one or more events included in the input data has on an occurrence of an outcome event. In some cases, output data that is generated based on such processing is referred to as contribution data.

Some conventional data processing systems attempt to achieve overarching key performance indicators via informed content distribution campaign strategies. Some conventional data processing systems attempt to monitor a performance of a content distribution campaign over a long period of time, a short period of time, or both, to inform adjustments to the content distribution campaign. However, conventional data processing systems that are directed to providing a content distribution campaign strategy are not well-equipped to adjust the content distribution campaign strategy based on a performance of the campaign, and vice-versa, because conventional data processing systems do not effectively generate contribution data based on both tracked data that corresponds to particular users and aggregate, non-user-attributable data.

For example, some conventional data processing systems attempt to regularize a multi-touch attribution model's output by applying constraints on the output or multiplying the output by multiplication factor, which is an inaccurate and trial-and-error-intensive process. Other conventional data processing systems provide independent strategizing and evaluation models that generate separate outputs, and attempt to reconcile the separate outputs of the independent models in various reports and dashboards, which is challenging and potentially confusing for a viewer of the reports and dashboards.

According to some aspects of the present disclosure, a data processing apparatus including a multi-touch attribution model, a training component, an aggregate attribution model, and a calibration component are provided. In some cases, the multi-touch attribution model computes channel contribution data based on individual-level user interaction data from a digital content channel. In some cases, the training component trains the aggregate attribution model based on the channel contribution data. In some cases, the calibration component generates an individual channel contribution value for the digital content channel based on the channel contribution data and the aggregate attribution model.

Accordingly, in some cases, by training the aggregate attribution machine learning model based on the output of the multi-touch attribution machine learning model, the aggregate attribution machine learning model learns to provide an output based on both aggregate, non-user-attributable data and knowledge provided by a machine learning model that processes user-attributable interaction data, such that the output of the aggregate attribution machine learning model is compatible with the channel contribution data.

Therefore, by generating the individual channel contribution value for the digital content channel based on the channel contribution data and the aggregate attribution machine learning model, the data processing system and apparatus provide contribution data that is calibrated based on both user-attributable interaction data and aggregate, non-user-attributable data, and is therefore more accurate than conventional contribution data provided by conventional data processing systems and methods.

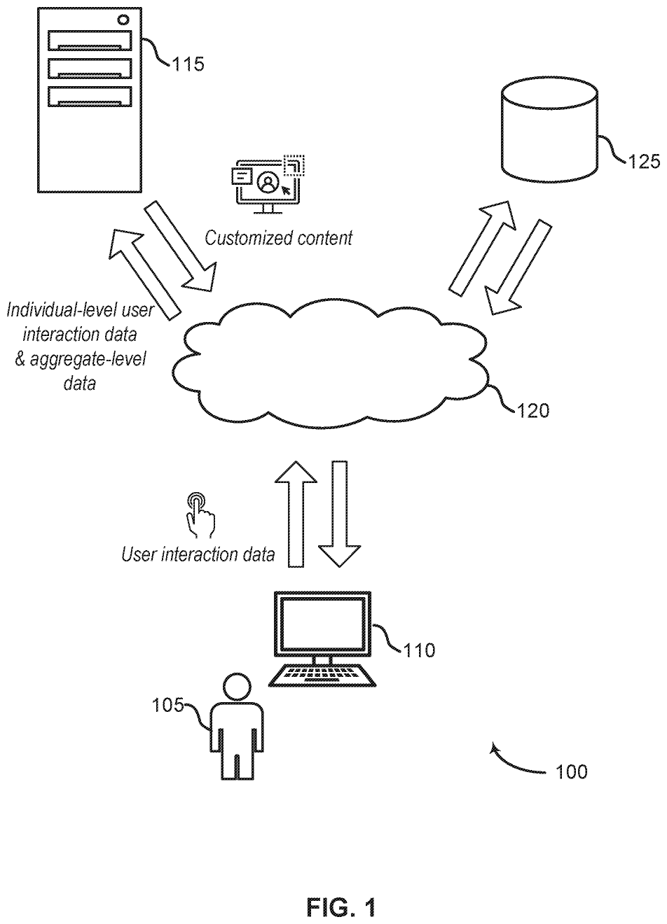

As used herein, “individual-level user interaction data” refers to data corresponding to an interaction between one or more users and one or more digital content channels. In some cases, the interaction comprises an interaction with content provided by a data processing apparatus (such as the data processing apparatus described with reference to FIGS. 1-3 and 6). In some cases, an item of individual-level user interaction data includes identifying information for a user (such as a third-party cookie, logged-in user identifier, or other item of information capable of identifying the user).

As used herein, a “third-party cookie” refers to a piece of data stored in a software application (such as a browser, a smartphone app, or the like) that records information relating to interactions of the user with one or more digital content channels via the software application.

As used herein, a “digital content channel” refers to a platform or medium through which digital content is distributed and/or consumed. As used herein, “digital content” refers to information that is capable of being stored, transmitted, and/or processed in a digital format, such as text, images, audio, video, or a combination thereof. Examples of a digital content channel include a website, an email platform, a social media platform, a video sharing platform, a podcast platform, an e-commerce platform, a streaming video service platform, a news aggregator platform, and the like. As used herein, a “channel” refers to a platform, medium, service, or physical location through which content (including digital content, physical media, goods, services, or a combination thereof) is distributed and/or consumed.

In some cases, content is provided as part of a content distribution campaign. As used herein, a “content distribution campaign” refers to a set of content and a plan for distributing the set of content (for example, a document including text describing a strategy for distributing the set of content) via one or more digital content channels.

As used herein, a “multi-touch attribution model” refers to a machine learning model for assigning credit to various touchpoints along an interaction path for a user. In some cases, to determine the effectiveness of a content distribution campaign, a multi-touch attribution model considers one or more interactions that a user has with content provided on a digital content channel.

According to some aspects, a multi-touch attribution model tracks an interaction path for a user (e.g., from initial awareness to final purchase). As used herein, an “interaction path” refers to a sequence of one or more interactions that a user has with content on one or more digital content channels. In some cases, the interaction path is described by the individual user-level interaction data.

In some cases, instead of attributing all the credit for the final purchase to the last touchpoint, the multi-touch attribution model analyzes one or more interactions of the interaction path and respectively assigns different weights to different touchpoints of the interaction path based on an influence of the different touchpoints on a decision-making process of the user.

As used herein, “channel contribution data” refers to data that indicates a contribution of an interaction described by the individual-level user interaction data towards the occurrence of a target outcome (such as a user conversion). In some cases, the contribution is therefore a weighted cause of an outcome.

As used herein, an “aggregate attribution model” refers to a correlation-based machine learning model that makes a prediction based on aggregate-level data (e.g., data that is not or cannot be directly attributed to a particular user). Examples of aggregate-level data include data provided by a content channel that is not attributed to a particular user, economic data (such as securities prices, indicators of governmental and non-governmental economic activity, interest rates, etc.), seasonal data, promotional information for a digital content campaign (such as promotional price information), and the like.

As used herein, an “individual channel contribution value” refers to a numerical indication of a contribution of a digital content channel to an event of the individual-level user interaction data. In some cases, the event is a target outcome (such as a conversion by a user). In some cases, an individual channel contribution value is generated by a calibration component based on a preliminary individual channel contribution value generated by the multi-touch attribution model. In some cases, the individual channel contribution value is generated by the multi-touch attribution model, and the individual channel contribution value is updated by the calibration component.

According to some aspects of the present disclosure, a synergistic framework is provided that employs both top-down and bottom-up approaches and is optimized to provide contribution data for both generating a content distribution campaign and evaluating a performance of the content distribution campaign.

In some cases, the multi-touch attribution model focuses on a micro level by drilling down into granular data, facilitating tactical decisions to enhance short-term performance across various channels and locales. In some cases, the multi-touch attribution model comprises a regression model. In some cases, the regression model leverages stitchable touchpoints (e.g., interactions with a user interaction path that are attributable to a particular user) to capture short-term (e.g., weekly) performance fluctuations in a content distribution campaign.

In some cases, the aggregate attribution model comprises a media mix modeling model that operates at a macro level, providing strategic insights to meet broad objectives by analyzing aggregate data. In some cases, the aggregate attribution model processes aggregate-level data, allowing the data processing apparatus to address non-stitchable touchpoints. In some cases, the aggregate attribution model leverages the aggregate-level data (including, for example, economic data, seasonality data, and promotional data).

In some cases, the calibration component generates or updates the individual channel contribution value based on both the multi-touch attribution model and the aggregate attribution model, allowing the data processing apparatus to provide a contribution metric that accurately accounts for both granular and aggregate data. In some cases, the calibration component encourages the individual channel contribution value to be accurate at an aggregate level while also providing insights at a touchpoint level. In some cases, the calibration component aligns the individual channel contribution value with weekly performance on different granularities.

According to some aspects, the data processing apparatus provides experimental testing of the individual channel contribution value. In some cases, the experimental testing serves as a robust benchmark that rigorously evaluates an efficacy of one or more of the multi-touch attribution model and the aggregate attribution model. In some cases, the data processing apparatus extends beyond data modeling and provides a holistic view of an entire content distribution campaign processing via one or more of an integration of a data lake, input data preprocessing, algorithmic optimization, continuous tracking of performance metrics, and monitoring and visualization tools.

According to some aspects, by integrating a top-down and bottom-up approach that combines a multi-touch attribution model, an aggregate attribution model, and a calibration component, the data processing apparatus achieves a more comprehensive understanding of content channel performance than conventional data processing systems. In some cases, the data processing apparatus provides a synergistic method that allows unified results from different measurement tactics to be evaluated, guiding more effective budget distribution and planning for future content distribution campaigns.

According to some aspects, the data processing apparatus deals with expectations on channel contributions in a systematic manner. In some cases, the data processing apparatus is able to provide an accurate individual channel contribution value even in an absence of third-party cookies. In some cases, the data processing apparatus comprises additional modeling approaches, such as insights from causal inference.

According to some aspects, the data processing apparatus offers a comprehensive end-to-end solution, proactively identifying data issues before model training and implementing data corrections where the data corrections are beneficial. In some cases, the data processing apparatus includes a safeguard system to manage data anomalies during model training (e.g. quarterly training) and scoring (e.g., weekly scoring).

An example of the present disclosure is used in a content distribution campaign context. For example, a content provider distributes various content (such as messages including text, images, and video, or a combination thereof) via a website (e.g., a first digital content channel) and a social media app (e.g., a second digital content channel) per an intended user interaction path, where an intended outcome at the end of the user interaction path is a purchase of goods by the user. In the example, the content provider tracks particular users' interactions with content provided via the website using third-party cookies to obtain individual-level user interaction data. However, the social media app does not use third-party cookies, and the content provider only has access to aggregate, non-stitchable data relating to the content provided on the social media app.

In some cases, the data processing apparatus obtains the individual-level user interaction data from the digital content channel and uses a multi-touch attribution model to compute channel contribution data based on the individual-level user interaction data, where the channel contribution data provides a weighted indication of an effect that interactions with content provided on the website had on a user making the intended purchase of goods.

In some cases, the data processing apparatus trains an aggregate attribution model based on the channel contribution data. In some cases, a calibration component of the data processing apparatus generates an individual channel contribution value based on the channel contribution data and the aggregate attribution model. For example, in some cases, the individual channel contribution value is based on the channel contribution data and is calibrated or updated according to an aggregate channel contribution value output by the trained aggregate attribution model based on the aggregate-level data provided by the social media app that is not attributable to particular users.

Accordingly, in some cases, the individual channel contribution value is an accurate weighted indication of an effect that interactions with the content provided on each of the website and the social media app had on the intended user purchase of goods, even in an absence of third-party cookies in the aggregate-level data.

In some cases, a campaign component of the data processing apparatus generates a content distribution campaign based on the individual channel contribution value (for example, by generating content and a plan to distribute the content on a channel that is indicated by the individual channel contribution value to have a relatively large effect on the target outcome).

In some cases, a user interface of the data processing apparatus provides the generated content of the content distribution campaign to a targeted user via a digital content channel targeted by the content distribution campaign. Accordingly, in some cases, the data processing apparatus is able to provide digital content and/or a content distribution campaign that is more effectively customized or targeted to particular users than digital content and/or a content distribution campaign provided by conventional data processing systems because of the accuracy of the individual channel contribution value.

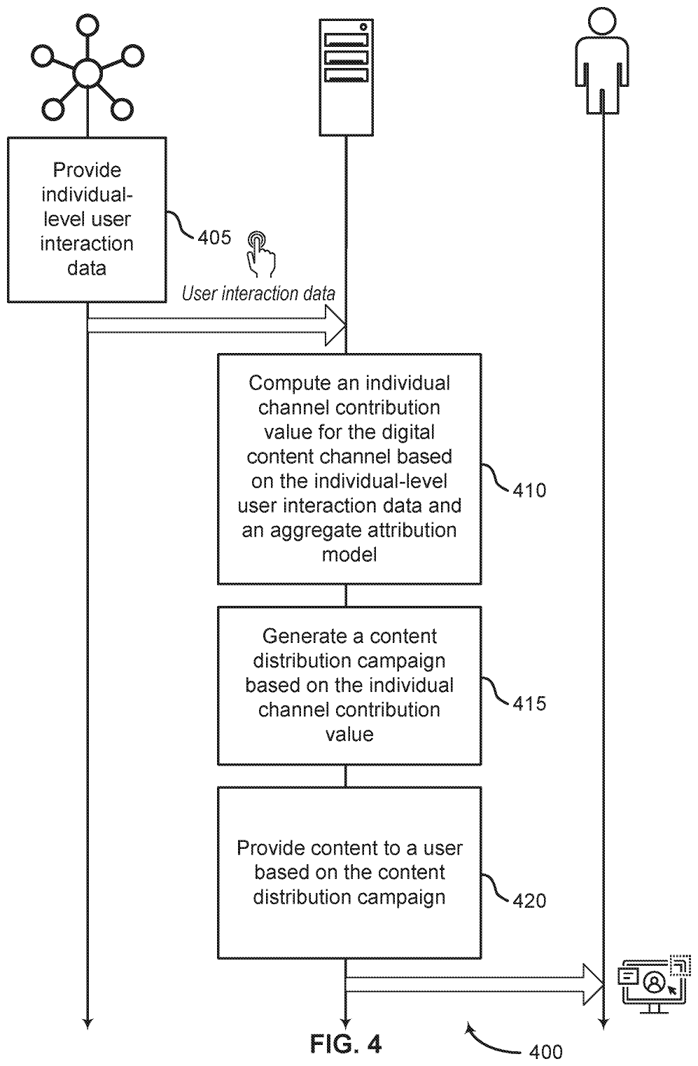

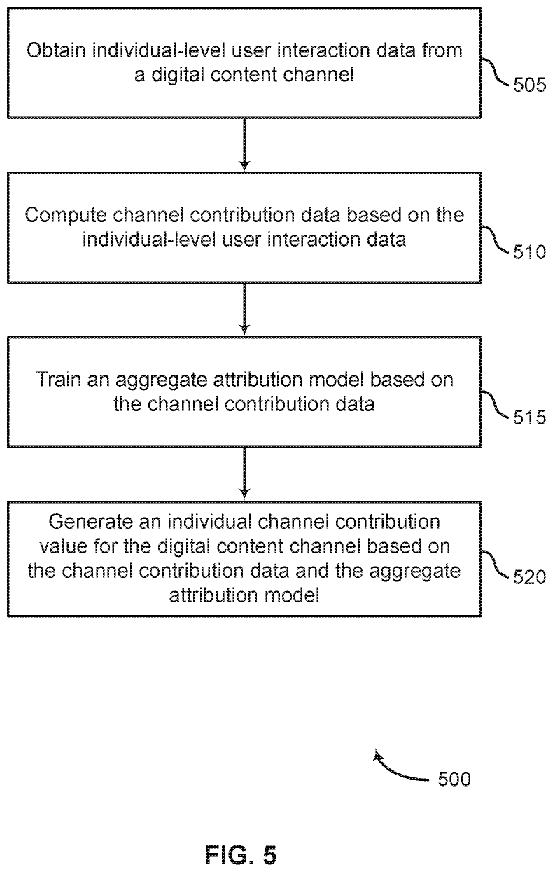

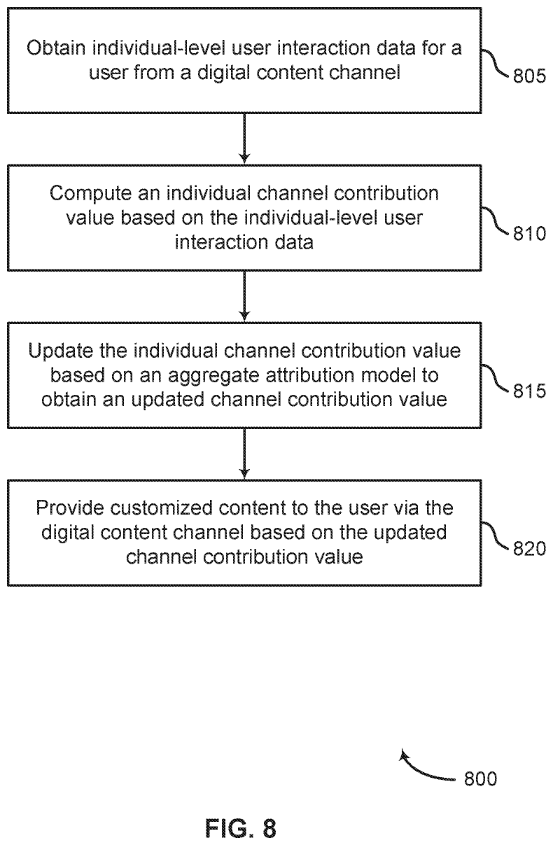

Further example applications of the present disclosure in a content distribution campaign context are provided with reference to FIGS. 4, 5, and 8. Details regarding the architecture of the data processing system are provided with reference to FIGS. 1-3 and 6. Examples of a process for training a machine learning model are provided with reference to FIGS. 5-7. Examples of a process for providing customized content are provided with reference to FIGS. 5 and 8.

### Data Processing System

A system and an apparatus for data processing is described. One or more aspects of the system and the apparatus include at least one memory; at least one processor executing instructions stored in the at least one memory; a multi-touch attribution model comprising multi-touch attribution parameters stored in the at least one memory, the multi-touch attribution model trained to compute channel contribution data based on individual-level user interaction data from a digital content channel; an aggregate attribution model comprising aggregate attribution parameters stored in the at least one memory, the aggregate attribution model trained to compute an aggregate channel contribution value for the digital content channel; and a calibration component configured to generate an individual channel contribution value for the digital content channel based on the channel contribution data and the aggregate channel contribution value.

Some examples of the system and the apparatus further include a content component configured to provide content to a user via the digital content channel based on the individual channel contribution value. Some examples of the system and the apparatus further include a campaign component configured to generate a content distribution campaign based on the individual channel contribution value. Some examples of the system and the apparatus further include a training component configured to update parameters of the aggregate attribution model based on the channel contribution data.

FIG. 1 shows an example of a data processing system 100 according to aspects of the present disclosure. The example shown includes user 105, user device 110, data processing apparatus 115, cloud 120, and database 125.

Referring to FIG. 1, user 105 interacts with digital content provided on a digital content channel included in cloud 120 via user device 110. The interaction results in user interaction data. Data processing apparatus 115 obtains individual-level user interaction data including the user interaction data from the digital content channel and aggregate-level data from cloud 120. In some cases, the aggregate-level data is stored in database 125. In some cases, database 125 is a data lake (e.g., a data format-agnostic database).

In some cases, data processing apparatus 115 generates an individual channel contribution value for the digital content channel based on the individual-level user interaction data and the aggregate-level data using a multi-touch attribution model, an aggregate attribution model trained based on the multi-touch attribution model, and a calibration component. In some cases, data processing apparatus 115 generates customized content for user 105 based on the individual channel contribution value. In some cases, data processing apparatus 115 provides the customized content to user 105 via user device 110.

According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by data processing apparatus 115. In some aspects, the user interface allows information to be communicated between user 105 and data processing apparatus 115.

According to some aspects, a user device user interface enables user 105 to interact with user device 110. In some embodiments, the user device user interface includes an audio device, such as an external speaker system, an external display device such as a display screen, or an input device (e.g., a remote-control device interfaced with the user interface directly or through an I/O controller module). In some cases, the user device user interface is a graphical user interface.

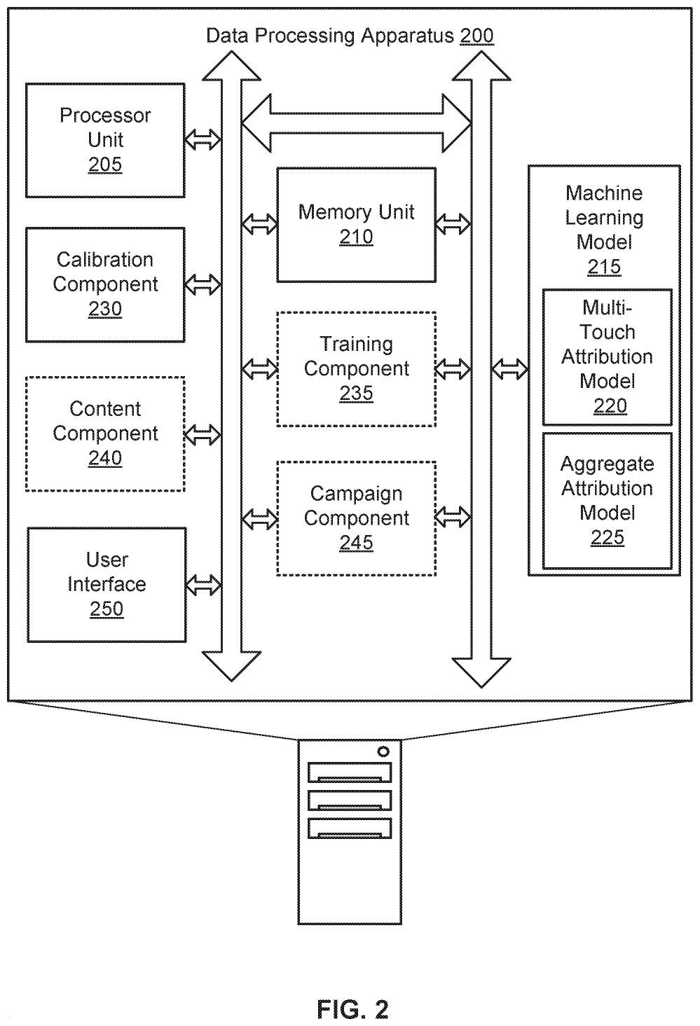

Data processing apparatus 115 is an example of, or includes aspects of, the corresponding element described with reference to FIGS. 2-3 and 6. According to some aspects, data processing apparatus 115 includes a computer-implemented network. In some embodiments, the computer-implemented network includes a machine learning model (such as the machine learning model described with reference to FIG. 2). In some embodiments, data processing apparatus 115 also includes at least one processor, a memory subsystem, a communication interface, an I/O interface, at least one user interface component, and a bus. Additionally, in some embodiments, data processing apparatus 115 communicates with user device 110 and database 125 via cloud 120.

In some cases, data processing apparatus 115 is implemented on a server. A server provides at least one function to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via at least one protocol, such as hypertext transfer protocol (HTTP), simple mail transfer protocol (SMTP), file transfer protocol (FTP), simple network management protocol (SNMP), and the like.

In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

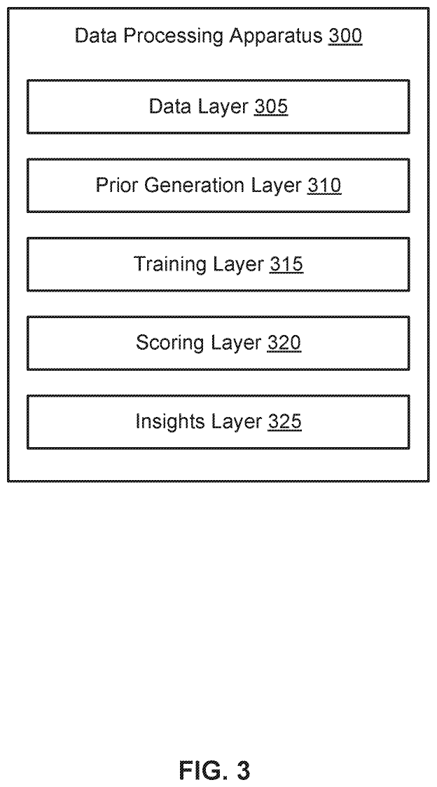

Further detail regarding the architecture of data processing apparatus 115 is provided with reference to FIGS. 2-3. Further detail regarding a process for training a machine learning model are provided with reference to FIGS. 5-7. Further detail regarding a process for providing customized content are provided with reference to FIGS. 5 and 8.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet.

Some large cloud networks have functions distributed over multiple locations from central servers. A server is designated an edge server if it has a direct or close connection to a user. In some cases, cloud 120 is limited to a single organization. In other examples, cloud 120 is available to many organizations.

In one example, cloud 120 includes a multi-layer communications network comprising multiple edge routers and core routers. In another example, cloud 120 is based on a local collection of switches in a single physical location. According to some aspects, cloud 120 provides communications between user device 110, data processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to data processing apparatus 115 and communicates with data processing apparatus 115 via cloud 120. According to some aspects, database 125 is included in data processing apparatus 115.

FIG. 2 shows an example of a data processing apparatus 200 according to aspects of the present disclosure. Data processing apparatus 200 is an example of, or includes aspects of, the corresponding element described with reference to FIGS. 1, 3, and 6. In one aspect, data processing apparatus 200 includes processor unit 205, memory unit 210, machine learning model 215, calibration component 230, training component 235, content component 240, campaign component 245, and user interface 250.

Processor unit 205 includes at least one processor. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 205 is configured to operate a memory array using a memory controller. In other cases, a memory controller is integrated into processor unit 205. In some cases, processor unit 205 is configured to execute computer-readable instructions stored in memory unit 210 to perform various functions. In some aspects, processor unit 205 includes special purpose components for modem processing, baseband processing, digital signal processing, or transmission processing.

Memory unit 210 includes at least one memory device. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 205 to perform various functions described herein.

In some cases, memory unit 210 includes a basic input/output system (BIOS) that controls basic hardware or software operations, such as an interaction with peripheral components or devices. In some cases, memory unit 210 includes a memory controller that operates memory cells of memory unit 210. For example, in some cases, the memory controller includes a row decoder, column decoder, or both. In some cases, memory cells within memory unit 210 store information in the form of a logical state.

According to some aspects, machine learning model 215 is implemented as software stored in memory unit 210 and executable by processor unit 205, as firmware, as at least one hardware circuit, or as a combination thereof. According to some aspects, machine learning model 215 comprises machine learning parameters stored in memory unit 210.

Machine learning parameters, also known as model parameters or weights, are variables that provide a behavior and characteristics of a machine learning model. In some cases, machine learning parameters are learned or estimated from training data and are used to make predictions or perform tasks based on learned patterns and relationships in the data.

In some cases, machine learning parameters are adjusted during a training process to minimize a loss function or maximize a performance metric. In some cases, a goal of the training process is to find optimal values for the parameters that allow the machine learning model to make accurate predictions or perform well on the given task.

For example, in some cases, during the training process, an algorithm adjusts machine learning parameters to minimize an error or loss between predicted outputs and actual targets according to optimization techniques like gradient descent, stochastic gradient descent, or other optimization algorithms. In some cases, once the machine learning parameters are learned from the training data, the machine learning parameters are used to make predictions on new, unseen data.

Artificial neural networks (ANNs) have numerous parameters, including weights and biases associated with each neuron in the network, which control a degree of connections between neurons and influence the ANN's ability to capture complex patterns in data.

An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, the node processes the signal and then transmits the processed signal to other connected nodes.

In some cases, the signals between nodes comprise real numbers, and the output of each node is computed by a function of the sum of the inputs of each node. In some examples, nodes determine the output using other mathematical algorithms, such as selecting the max from the inputs as the output, or any other suitable algorithm for activating the node. In some cases, each node and edge are associated with at least one node weight that determines how the signal is processed and transmitted.

In ANNs, a hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to increase the accuracy of the result (e.g., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

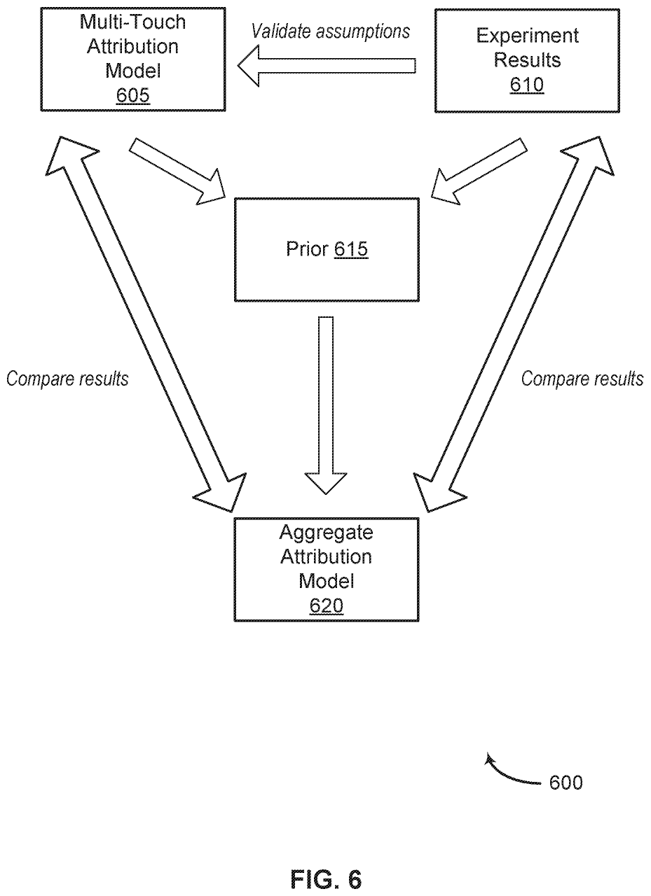

In one aspect, machine learning model 215 includes multi-touch attribution model 220 and aggregate attribution model 225. Multi-touch attribution model 220 is an example of, or includes aspects of, the corresponding element described with reference to FIG. 6. Aggregate attribution model 225 is an example of, or includes aspects of, the corresponding element described with reference to FIG. 6.

According to some aspects, multi-touch attribution model 220 is implemented as software stored in memory unit 210 and executable by processor unit 205, as firmware, as at least one hardware circuit, or as a combination thereof. According to some aspects, multi-touch attribution model 220 comprises multi-touch attribution parameters (e.g., machine learning parameters) stored in memory unit 210. According to some aspects, multi-touch attribution model 220 comprises one or more ANNs trained to compute channel contribution data based on individual-level user interaction data from a digital content channel.

According to some aspects, multi-touch attribution model 220 obtains individual-level user interaction data from a digital content channel. In some examples, multi-touch attribution model 220 computes channel contribution data based on the individual-level user interaction data. In some examples, multi-touch attribution model 220 computes a preliminary individual channel contribution value for the digital content channel. In some examples, multi-touch attribution model 220 computes the channel contribution data for an interaction path, where the channel contribution data corresponds to a set of channels, respectively.

According to some aspects, multi-touch attribution model 220 obtains individual-level user interaction data for a user from a digital content channel. In some examples, multi-touch attribution model 220 computes an individual channel contribution value based on the individual-level user interaction data. In some examples, multi-touch attribution model 220 computes a set of individual channel contribution values for an interaction path, where the set of individual channel contribution values corresponds to a set of channels, respectively.

According to some aspects, a multi-touch attribution model such as multi-touch attribution model 220 comprises a model for assigning credit to various touchpoints along an interaction path for a user. In some cases, to determine the effectiveness of a content distribution campaign, a multi-touch attribution model considers one or more interactions that a user has with content provided in accordance with the content distribution campaign (for example, before making a purchase decision relating to the content distribution campaign).

According to some aspects, a multi-touch attribution model tracks an interaction path for a user (e.g., from initial awareness to final purchase). In some cases, instead of attributing all the credit for the final purchase to the last touchpoint, the multi-touch attribution model analyzes one or more interactions of the interaction path and respectively assigns different weights to different touchpoints of the interaction path based on an influence of the different touchpoints on a decision-making process of the user.

According to some aspects, multi-touch attribution model 220 comprises a regression model. In some cases, a regression model is a statistical model that predicts a value of a dependent variable (an outcome) based on values of one or more independent variables (predictors). In some cases, regression models indicate how changes in one or more variables are associated with changes in another variable. In an example, in some cases, multi-touch attribution model 220 predicts sales of a product (an outcome) based on factors such as content campaign expenditure, pricing, and seasonality (predictors).

According to some aspects, the regression model is implemented as a linear regression model. In some cases, linear regression assumes a linear relationship between one or more independent variables and the dependent variable and fits a straight line to data points, while attempting to minimize a difference between observed and predicted values.

According to some aspects, the regression model is implemented as a polynomial regression model. In some cases, polynomial regression models a relationship between the independent and dependent variables as an nth-degree polynomial, allowing for more complex relationships between variables to be captured.

According to some aspects, aggregate attribution model 225 is implemented as software stored in memory unit 210 and executable by processor unit 205, as firmware, as at least one hardware circuit, or as a combination thereof. According to some aspects, aggregate attribution model 225 comprises aggregate attribution parameters (e.g., machine learning parameters) stored in memory unit 210. According to some aspects, aggregate attribution model 225 comprises one or more ANNs trained to compute an aggregate channel contribution value for the digital content channel.

According to some aspects, aggregate attribution model 225 computes an aggregate channel contribution value for the digital content channel, where the individual channel contribution value is generated based on the preliminary individual channel contribution value and the aggregate channel contribution value. In some aspects, aggregate attribution model 225 is trained using the channel contribution data and experimental testing data. In some examples, aggregate attribution model 225 computes a set of aggregate channel contribution values corresponding to the set of channels, respectively.

According to some aspects, aggregate attribution model 225 computes an aggregate channel contribution value, where the individual channel contribution value is updated based on the aggregate channel contribution value. In some examples, aggregate attribution model 225 computes a set of aggregate channel contribution values corresponding to the set of channels, respectively.

According to some aspects, aggregate attribution model 225 comprises a correlation-based model that makes a prediction based on aggregate-level data (e.g., data that is not or cannot be directly attributed to a particular user). Examples of aggregate-level data include data provided by a content channel that is not attributed to a particular user, economic data (such as securities prices), seasonal data, promotional information for a digital content campaign, and the like.

In some cases, aggregate attribution model 225 comprises a media mix modeling (MMM) model. In some cases, an MMM model comprises a statistical model used to determine an optimal allocation of resources across one or more channels to maximize a return on an investment (ROI). In some cases, aggregate attribution model 225 is trained to understand how content distributed via different content channels contributes to key performance indicators (KPIs) for the content. In some cases, by analyzing historical data on content spending, conversions, and other relevant factors, aggregate attribution model 225 quantifies an impact of a content channel on a desired outcome.

According to some aspects, calibration component 230 is implemented as software stored in memory unit 210 and executable by processor unit 205, as firmware, as at least one hardware circuit, or as a combination thereof. According to some aspects, calibration component 230 is configured to generate an individual channel contribution value for the digital content channel based on the channel contribution data and the aggregate channel contribution value.

According to some aspects, calibration component 230 generates an individual channel contribution value for the digital content channel based on the channel contribution data and the aggregate attribution model 225. In some aspects, the individual channel contribution value indicates a contribution of the digital content channel to an event of the individual-level user interaction data.

In some examples, calibration component 230 normalizes the individual channel contribution value based on a set of individual channel contribution values corresponding to a set of content channels. In some examples, calibration component 230 generates a set of individual channel contribution values based on the set of aggregate channel contribution values.

According to some aspects, calibration component 230 updates the individual channel contribution value based on aggregate attribution model 225 to obtain an updated channel contribution value. In some aspects, the updated individual channel contribution value indicates a contribution of the digital content channel to an event of the individual-level user interaction data. In some examples, calibration component 230 updates each of the set of individual channel contribution values based on the set of aggregate channel contribution values.

According to some aspects, training component 235 is implemented as software stored in memory unit 210 and executable by processor unit 205, as firmware, as at least one hardware circuit, or as a combination thereof. According to some aspects, training component 235 is omitted from data processing apparatus 200. According to some aspects, training component 235 is implemented as software stored in a memory unit of a separate apparatus and executable by a processor unit of the separate apparatus, as firmware of the separate apparatus, as at least one hardware circuit of the separate apparatus, or as a combination thereof. According to some aspects, data processing apparatus 200 communicates with the separate apparatus such that training component 235 performs the functions described herein.

According to some aspects, training component 235 trains aggregate attribution model 225 based on the channel contribution data. In some examples, training component 235 generates an attribution prior based on the channel contribution data. In some examples, training component 235 computes an objective function for aggregate attribution model 225 based on the attribution prior. In some examples, training component 235 updates parameters of aggregate attribution model 225 based on the objective function. According to some aspects, training component 235 is configured to update parameters of aggregate attribution model 225 based on the channel contribution data.

According to some aspects, training component 235 trains aggregate attribution model 225 using the individual channel contribution value and experimental testing data. In some examples, training component 235 generates an attribution prior based on the individual channel contribution value. In some examples, training component 235 computes an objective function for aggregate attribution model 225 based on the attribution prior. In some examples, training component 235 updates parameters of aggregate attribution model 225 based on the objective function.

According to some aspects, content component 240 is implemented as software stored in memory unit 210 and executable by processor unit 205, as firmware, as at least one hardware circuit, or as a combination thereof. According to some aspects, content component 240 is omitted from data processing apparatus 200. According to some aspects, content component 240 is implemented as software stored in a memory unit of a separate apparatus and executable by a processor unit of the separate apparatus, as firmware of the separate apparatus, as at least one hardware circuit of the separate apparatus, or as a combination thereof. According to some aspects, data processing apparatus 200 communicates with the separate apparatus such that content component 240 performs the functions described herein.

According to some aspects, content component 240 is configured to provide content to a user via the digital content channel based on the individual channel contribution value. According to some aspects, content component 240 provides customized content to the user via the digital content channel based on the updated channel contribution value. According to some aspects, content component 240 comprises one or more generative machine learning models (such as a large language model, a diffusion model, a transformer, etc.) trained to generate the content (such as text, an image, audio, video, etc.) based on the individual channel contribution value.

According to some aspects, campaign component 245 is implemented as software stored in memory unit 210 and executable by processor unit 205, as firmware, as at least one hardware circuit, or as a combination thereof. According to some aspects, campaign component 245 is omitted from data processing apparatus 200. According to some aspects, campaign component 245 is implemented as software stored in a memory unit of a separate apparatus and executable by a processor unit of the separate apparatus, as firmware of the separate apparatus, as at least one hardware circuit of the separate apparatus, or as a combination thereof. According to some aspects, data processing apparatus 200 communicates with the separate apparatus such that campaign component 245 performs the functions described herein.

According to some aspects, campaign component 245 is configured to generate a content distribution campaign based on the individual channel contribution value. According to some aspects, campaign component 245 generates a content distribution campaign based on the updated individual channel contribution value. According to some aspects, campaign component 245 comprises one or more generative machine learning models (such as a large language model, a diffusion model, a transformer, etc.) trained to generate the content distribution campaign (such as text, an image, audio, video, etc.) based on the individual channel contribution value.

According to some aspects, user interface 250 is implemented as software stored in memory unit 210 and executable by processor unit 205. According to some aspects, user interface 250 is a graphical user interface. According to some aspects, user interface 250 is displayed on a user device by data processing apparatus 200. According to some aspects, user interface 250 is configured to display content provided by data processing apparatus 200.

FIG. 3 shows an example of data processing apparatus layers according to aspects of the present disclosure. Data processing apparatus 300 is an example of, or includes aspects of, the corresponding element described with reference to FIGS. 1, 2, and 6. In one aspect, data processing apparatus 300 includes data layer 305, prior generation layer 310, training layer 315, scoring layer 320, and insights layer 325.

Referring to FIG. 3, in some cases, data processing apparatus 300 comprises a framework of five layers. In some cases, each of the layers build upon each other. In some cases, each of the layers work together to provide data-driven results that align with temporal content channel performance observations.

According to some aspects, data layer 305 is a foundational layer comprising a backend data lake repository comprising a standardized metadata structure. In some cases, data layer 305 comprises a database, such as the database described with reference to FIG. 1. In some cases, data layer 305 comprises environmental variables (such as seasonality variables, promotional variables, economic variables, or a combination thereof), individual user-level data, aggregate-level data (e.g., for cookieless channels), or a combination thereof.

In some cases, a data lake comprises a central storage repository capable of handling massive amounts of structured, semi-structured, and/or unstructured data. In some cases, unlike traditional data warehousing methods, data lakes store information in a raw format, maintaining native structure of the data until the data is accessed for analysis or other purposes.

In some cases, a key feature of a data lake is scalability, allowing the data lake to accommodate large volumes of data. In some cases, a data lake is capable of storing data of various data types, including structured data from databases, semi-structured data such as JSON or XML, unstructured data such as text documents, images, videos, and sensor data, or a combination thereof. In some cases, unlike traditional databases that enforce schema at write-time, data lakes apply schema on read, meaning that data is stored as-is without a predefined schema, and the schema is applied at the time of data access or analysis.

In some cases, a data lake supports various processing frameworks and tools for data ingestion, transformation, and analysis, such as batch processing, stream processing, and machine learning frameworks. In some cases, a data lake integrates with other data management systems and analytics platforms, enabling seamless data exchange and interoperability across a data ecosystem.

According to some aspects, prior generation layer 310 includes a training component (such as the training component described with reference to FIG. 2) to generate a prior based on experimental results, such as results from platform-specific testing or matched market tests. In some cases, the prior is generated based on an output of a multi-touch attribution model (such as the multi-touch attribution model described with reference to FIGS. 2 and 6).

In some cases, matched market tests are used to assess an effectiveness of various strategies, such as content distribution campaigns or pricing adjustments. In some cases, in a matched market test, a tester compares a performance of a group within a market (such as a geographical area) exposed to a particular intervention (e.g., a text group) against a group in a different market that is not exposed to the intervention (e.g., a control group). In some cases, a matched market test includes selecting comparable markets or groups based on demographic characteristics, geographic location, and other relevant factors.

In some cases, before the intervention is implemented, baseline data is collected on key performance metrics for both the test and control groups. In some cases, after the intervention is implemented, the performance of both groups is monitored and measured. In some cases, statistical analysis is then conducted to determine whether any observed differences in performance among the test group and the control group are statistically significant.

According to some aspects, training layer 315 comprises a training component (such as the training component described with reference to FIG. 2). In some cases, the training component is configured to train one or more of the multi-touch attribution model and the aggregate attribution model.

According to some aspects, scoring layer 320 comprises one or more of the multi-touch attribution model, the aggregate attribution model, and the calibration component. In some cases, scoring layer 320 provides an evaluation of performance over a past period of time. In some cases, scoring layer 320 provides a regular, ongoing (such as weekly) performance assessment.

According to some aspects, scoring layer 320 provides safeguard protocols to handle anomalies in weekly data, such as missing days or deviations from expected trends. In some cases, scoring layer 320 intelligently projects incomplete data to fill gaps and impose limits on variations to keep changes within plausible bounds.

According to some aspects, scoring layer 320 provides a calibration process that encourages predictions at an aggregate level to remain accurate while also providing detailed insights at a touchpoint level for various digital content channels, which assists in aligning outputs of the machine learning model with weekly performance on different granularities.

According to some aspects, insights layer 325 generates return on investment curves and displays the return on investment curves via a user interface of data processing apparatus 300. In some cases, insights layer 325 provides year-over-year comparative views via the user interface. In some cases, insights layer 325 provides budget allocation recommendations via the user interface.

According to some aspects, insights layer 325 comprises a data governance and quality assurance (DGR/QA) dashboard. In some cases, the DGR/QA is provided by the user interface. In some cases, the DGR/QA dashboard proactively identifies data inconsistencies and initiates corrective measures. In an example, if there is any data discrepancy found in an overlapping period of two data pulls for a retraining job, the DGR/QA dashboard automatically sends out email alerts and triggers appropriate corrective pipelines tailored to one or more of geographical areas, digital content channels, and a scale of the discrepancy.

### Data Processing

A method for data processing is described with reference to FIGS. 4-7. One or more aspects of the method include obtaining individual-level user interaction data from a digital content channel; computing channel contribution data based on the individual-level user interaction data; training an aggregate attribution model based on the channel contribution data; and generating an individual channel contribution value for the digital content channel based on the channel contribution data and the aggregate attribution model. In some aspects, the individual channel contribution value indicates a contribution of the digital content channel to an event of the individual-level user interaction data. In some aspects, the aggregate attribution model is trained using the channel contribution data and experimental testing data.

Some examples of the method further include computing a preliminary individual channel contribution value for the digital content channel. Some examples further include computing an aggregate channel contribution value for the digital content channel, wherein the individual channel contribution value is generated based on the preliminary individual channel contribution value and the aggregate channel contribution value.

Some examples of the method further include generating an attribution prior based on the channel contribution data. Some examples further include computing an objective function for the aggregate attribution model based on the attribution prior. Some examples further include updating parameters of the aggregate attribution model based on the objective function. Some examples of the method further include normalizing the individual channel contribution value based on a plurality of individual channel contribution values corresponding to a plurality of content channels.

Some examples of the method further include computing the channel contribution data for an interaction path, wherein the channel contribution data corresponds to a plurality of channels, respectively. Some examples further include computing a plurality of aggregate channel contribution values corresponding to the plurality of channels, respectively. Some examples further include generating a plurality of individual channel contribution values based on the plurality of aggregate channel contribution values.

Some examples of the method further include providing content to a user via the digital content channel based on the individual channel contribution value. Some examples of the method further include generating a content distribution campaign based on the individual channel contribution value.

FIG. 4 shows an example of a method 400 for generating a content distribution campaign according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 4, according to some aspects, a data processing system provides customized content a user according to a content distribution campaign based on an individual channel contribution value. In an attempt to develop an effective framework for content campaign planning and measurement, some conventional data processing systems use a multi-touch attribution model to assign credit to various touchpoints of a user interaction path. However, for conventional data processing systems, some aggregate data that is beneficial for properly assigning credit is not able to be associated with a particular user (for example, data provided by a cookie-less environment or channel).

Accordingly, some aspects of the present disclosure generate an individual channel contribution value based on an output of both a multi-touch attribution model and an aggregate attribution model. In some cases, the aggregate attribution model is trained based on an output of the multi-touch attribution model. By generating the individual channel contribution value based on both the multi-touch attribution model and the aggregate attribution model, the individual channel contribution value is able to more accurately assign credit to touchpoints of user interaction path on a channel than conventional data processing systems. In turn, in some cases, the data processing system is therefore able to generate customized content based on the individual channel contribution value that is likely to promote a desired user action when the customized content is received by the user.

At operation 405, a digital content channel provides individual-level user interaction data. In some cases, the operations of this step refer to, or are performed by, a digital content channel. According to some aspects, the digital content channel provides the individual-level user interaction data as described with reference to FIG. 5.

At operation 410, the system computes an individual channel contribution value for the digital content channel based on the individual-level user interaction data and an aggregate attribution model. In some cases, the operations of this step refer to, or are performed by, a data processing apparatus as described with reference to FIGS. 1-3 and 6. According to some aspects, the data processing apparatus computes the individual channel contribution value as described with reference to FIG. 5.

At operation 415, the system generates a content distribution campaign based on the individual channel contribution value. In some cases, the operations of this step refer to, or are performed by, a data processing apparatus as described with reference to FIGS. 1-3 and 6. According to some aspects, the data processing apparatus generates the content distribution campaign as described with reference to FIG. 5.

At operation 420, the system provides content to a user based on the content distribution campaign. In some cases, the operations of this step refer to, or are performed by, a data processing apparatus as described with reference to FIGS. 1-3 and 6. According to some aspects, the data processing apparatus displays the content to the user (such as the user described with reference to FIG. 1) via a user interface (such as the user interface described with reference to FIG. 2) displayed by the data processing apparatus on a user device (such as the user device described with reference to FIG. 1).

FIG. 5 shows an example of a method 500 for data processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

Referring to FIG. 5, according to some aspects, a data processing apparatus (such as the data processing apparatus described with reference to FIGS. 1-3 and 6) generates an individual channel contribution value for a digital content channel based on an aggregate attribution model and channel contribution data provided by a multi-touch attribution model, which allows the individual channel contribution value to account for aggregate-level data, thereby providing a more accurate individual channel contribution value than conventional data processing systems.

At operation 505, the system obtains individual-level user interaction data from a digital content channel. In some cases, the operations of this step refer to, or are performed by, a multi-touch attribution model as described with reference to FIGS. 2 and 6. According to some aspects, the data processing apparatus monitors the digital content channel to obtain the individual-level user interaction data. In some cases, the data processing apparatus requests the individual-level user interaction data from the data processing apparatus via an API call.

As used herein, “individual-level user interaction data” refers to data corresponding to an interaction between one or more users and one or more digital content channels. In some cases, the interaction comprises an interaction with content provided by a data processing apparatus (such as the data processing apparatus described with reference to FIGS. 1-3 and 6). In some cases, an item of individual-level user interaction data includes identifying information for a user (such as a third-party cookie, logged-in user identifier, or other item of information capable of identifying the user).

As used herein, a “third-party cookie” refers to a piece of data stored in a software application (such as a browser, a smartphone app, or the like) that records information relating to interactions of the user with one or more digital content channels via the software application.

As used herein, a “digital content channel” refers to a platform or medium through which digital content is distributed and/or consumed. As used herein, “digital content” refers to information that is capable of being stored, transmitted, and/or processed in a digital format, such as text, images, audio, video, or a combination thereof. Examples of a digital content channel include a website, an email platform, a social media platform, a video sharing platforms, a podcast platforms, an e-commerce platforms, a streaming video service platform, a news aggregator platform, and the like. As used herein, a “channel” refers to a platform, medium, service, or physical location through which content (including digital content, physical media, goods, services, or a combination thereof) is distributed and/or consumed.

At operation 510, the system computes channel contribution data based on the individual-level user interaction data. In some cases, the operations of this step refer to, or are performed by, a multi-touch attribution model as described with reference to FIGS. 2 and 6.

As used herein, “channel contribution data” refers to data that indicates a contribution of an interaction described by the individual-level user interaction data towards the occurrence of a target outcome (such as a user conversion). In some cases, the contribution is therefore a weighted cause of an outcome.

According to some aspects, the multi-touch attribution model computes the channel contribution data for an interaction path, wherein the channel contribution data corresponds to a plurality of channels (e.g., digital channels), respectively. As used herein, an “interaction path” refers to a sequence of one or more interactions that a user has with content. In some cases, the interaction path is described by the individual user-level interaction data.

According to some aspects, the channel contribution value is a channel-level contribution percentage p_{tci} for a channel i. According to some aspects, a calibration component of the data processing apparatus (such as the calibration component described with reference to FIGS. 2 and 6) computes a marginal score mᵢⱼ (e.g., a Shapley score) in interaction path j.

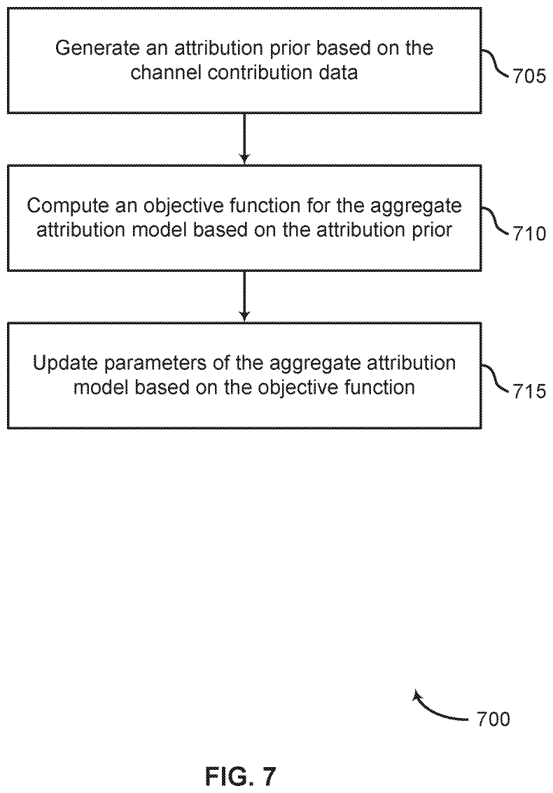

At operation 515, the system trains an aggregate attribution model based on the channel contribution data. In some cases, the operations of this step refer to, or are performed by, a training component as described with reference to FIG. 2. According to some aspects, the training component trains the aggregate attribution model as described with reference to FIGS. 6-7.

At operation 520, the system generates an individual channel contribution value for the digital content channel based on the channel contribution data and the aggregate attribution model. In some cases, the operations of this step refer to, or are performed by, a calibration component as described with reference to FIG. 2.

As used herein, an “individual channel contribution value” refers to a numerical indication of a contribution of a digital content channel to an event of the individual-level user interaction data. In some cases, the event is a target outcome (such as a conversion by a user). In some cases, an individual channel contribution value is generated by a calibration component based on a preliminary individual channel contribution value generated by the multi-touch attribution model. In some cases, the individual channel contribution value is generated by the multi-touch attribution model, and the individual channel contribution value is updated by the calibration component.

According to some aspects, the multi-touch attribution model computes the aggregate channel contribution value (e.g., a channel-level contribution percentage \hat{p}_{tci}) for channel i. In some cases, the multi-touch attribution model computes the channel-level contribution percentage \hat{p}_{tci} based on the channel contribution value. In some cases, the multi-touch attribution model computes the channel-level contribution percentage \hat{p}_{tci} based on aggregate-level data (such as one or more of non-stitchable interaction data, economic data such as price indexes, seasonality data, and promotional data).

According to some aspects, the multi-touch attribution model computes a plurality of aggregate channel contribution values corresponding to the plurality of channels, respectively. According to some aspects, the calibration component computes an aggregate marginal score m′ᵢⱼ=mᵢⱼ*(\hat{p}_{tci}/p_{tci}).

According to some aspects, for interaction paths with Σᵢm′ᵢⱼ>1, the calibration component removes 1−Σᵢm′ᵢⱼ from channels including enlarged contributions, and calculates total residual contributions for each channel (e.g., contributions exceeding 1) to allocate to other interaction paths to obtain the individual channel contribution value Sᵢ=\hat{p}_{tci}*{number of achieved target outcomes}. In some cases, the calibration component generates a plurality of individual channel contribution values based on the plurality of aggregate channel contribution values.

According to some aspects, the calibration component normalizes the individual channel contribution value based on a plurality of individual channel contribution values corresponding to a plurality of content channels. For example, in some cases, the calibration component adjusts interaction paths with Σᵢm′ᵢⱼ<1 to absorb the residual contributions (e.g., channel contributions that cause the aggregate marginal score to be greater than 1).

In some cases, given Nᵢ paths having a non-zero score for channel i, the remainder of paths with Σᵢm′ᵢⱼ<1 are denoted as Φ. In some cases, the calibration component computes

$${avg}_{i} = \frac{{residual}_{i}}{{N}_{i}}$$

for different i. In some cases, the calibration component finds all interaction paths for which 1−Σᵢm′ᵢⱼ−Σᵢavgᵢ{mᵢⱼ≠0}<0 and allocates as many scores to each channel as possible to update, residual Φ, Nᵢ, and avgᵢ. In some cases, if the calibration component does not find any interaction path that violates the condition, the calibration component allocates avgᵢ to a particular channel for the rest of the interaction path. In some cases, the calibration component proceeds with a goal of generating a marginal sum within an interaction path of less than or equal to one.

In an example, given an interaction path and four digital content channels i=[1 . . . 4], the multi-touch attribution model determines four channel contribution values C₁+C₂+C₃+C₄=1 for each of the digital content channels. In the example, the aggregate attribution model computes four aggregate channel contribution values based on the four channel contribution values: (C₁+0.1)+(C₂+0.2)+(C₃+0.3)+(C₄−0.4)=1+0.2. In the example, based on the four contribution values, the calibration component obtains four individual channel contribution values S_{i=[1 . . . 4]}. In the example, the calibration component normalizes the individual channel contribution values by lowering C₁, C₂, and C₃ by the residual 0.2 in total: (C₁+0.1−0.1/3)+(C₂+0.2−0.2/3)+(C₃+0.3−0.3/3)+ (C₄−0.4)=1, and determining updated individual channel contribution values S_{i=[1 . . . 4]}.

Accordingly, the data processing apparatus provides an individual contribution value for a digital content channel that allows the data processing apparatus to accurately determine how much the digital content channel contributed to an occurrence of a target outcome based on both user-stitchable and non-stitchable data.

In some cases, a content component of the data processing apparatus (such as the content component described with reference to FIG. 2) provides content to a user via the digital content channel based on the individual channel contribution value. In some cases, the content component generates the content (e.g., algorithmically, via a generative machine learning process, or a combination thereof). In some cases, the content component retrieves the content from a database (such as the database described with reference to FIG. 1). In some cases, the individual channel contribution indicates to the content component which content provided on which digital content channel would be most effective in encouraging the user to perform a particular action that results in a target outcome (e.g., a purchase by the user).

In some cases, a campaign component of the data processing apparatus (such as the content component described with reference to FIG. 2) generates a content distribution campaign based on the individual channel contribution value. In some cases, the content component generates the content distribution campaign algorithmically, via a generative machine learning process, or a combination thereof. In some cases, the content component distributes content to a user according to the content distribution campaign.

FIG. 6 shows an example of training an aggregate attribution model 620 according to aspects of the present disclosure. Data processing apparatus 600 is an example of, or includes aspects of, the corresponding element described with reference to FIGS. 1-3. In one aspect, data processing apparatus 600 includes multi-touch attribution model 605, experiment results 610, prior 615, and aggregate attribution model 620. Multi-touch attribution model 605 is an example of, or includes aspects of, the corresponding element described with reference to FIG. 2. Aggregate attribution model 620 is an example of, or includes aspects of, the corresponding element described with reference to FIG. 2.

Referring to FIG. 6, in some cases, a training component (such as the training component described with reference to FIG. 2) generates prior 615 (e.g., an attribution prior) based on channel contribution data generated by multi-touch attribution model 605. In some cases, prior 615 includes the channel contribution data. In some cases, prior 615 includes data obtained from experiment results 610 (e.g., data obtained via in-platform experimentation and matched market testing). In some cases, the training component trains aggregate attribution model 620 based on prior 615 as described with reference to FIG. 7.

In some cases, data processing apparatus 600 uses experiment results 610 to validate assumptions of multi-touch attribution model 605. In some cases, data processing apparatus 600 compares output results between respective outputs of aggregate attribution model 620, multi-touch attribution model 605, and experiment results 610.

FIG. 7 shows an example of a method 700 for updating parameters of an aggregate attribution model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system generates an attribution prior based on the channel contribution data. In some cases, the operations of this step refer to, or are performed by, a training component as described with reference to FIG. 2.

Referring to FIG. 7, in some cases, the training component generates the attribution prior based on channel contribution data generated by a multi-touch attribution model (such as the multi-touch attribution model described with reference to FIGS. 2 and 6). In some cases, the attribution prior includes the channel contribution data. In some cases, the attribution prior includes testing data obtained from via in-platform experimentation and matched market testing.

At operation 710, the system computes an objective function for the aggregate attribution model based on the attribution prior. In some cases, the operations of this step refer to, or are performed by, a training component as described with reference to FIG. 2.

An objective function refers to a function that impacts how a machine learning model is trained in a supervised learning model. For example, during each training iteration, the output of the machine learning model is compared to the known annotation information in the training data. The objective function provides a value for how close the predicted annotation data is to the actual annotation data. After computing the value, the parameters of the machine learning model are updated accordingly and a new set of predictions are made during the next iteration, in some cases with a goal of minimizing the value.

Supervised learning is a machine learning technique based on learning a function that maps an input to an output based on example input-output pairs. Supervised learning generates a function for predicting labeled data based on labeled training data consisting of a set of training examples. In some cases, each example is a pair consisting of an input object (e.g., a vector) and a desired output value (e.g., a single value or an output vector). In some cases, a supervised learning algorithm analyzes the training data and produces the inferred function, which is used for mapping new examples. In some cases, the learning results in a function that correctly determines the class labels for unseen instances. For example, the learning algorithm generalizes from the training data to unseen examples.

According to some aspects, the training component computes the objective function as:

$${β}^{*} = {arg min}_{β} {\sum }_{j = 0}^{g} {( {c}_{j} ( β ) - {\tilde{c}}_{j} )}^{2} + λ {\sum }_{i = 1}^{n} {( exp \{ {y}_{i} \} - exp \{ {X}_{i} , β \} )}^{2} \qquad ( 1 )$$

In some cases, β represents the multi-touch attribution parameters of the multi-touch attribution model, cⱼ (β) represents a contribution from channel j as a function of β, \tilde{c}ⱼ is an expected contribution from channel j, yᵢ is a multi-touch attribution model predicted outcome for time period i, Xᵢ is an actual outcome for time period i, the first summation represents a distance between model-predicted and expected channel contributions towards an outcome, and the second summation represents model goodness-of-fit. In some cases, λ is a non-negative hyperparameter to avoid compromising model fit as a result of moving closer to expected channel contributions.

At operation 715, the system updates parameters of the aggregate attribution model based on the objective function. In some cases, the operations of this step refer to, or are performed by, a training component as described with reference to FIG. 2.

In some cases, the training component updates the parameters of the aggregate attribution model using a transfer learning approach. In transfer learning, knowledge gained from training a model on one task is applied to a related task. Instead of starting from scratch, a pre-trained model is adapted to the new task, improving its performance. In some cases, the parameters of the aggregate attribution model are updated using feature extraction. In feature extraction, learned features are used in a new model, with new layers being trained on the target task's dataset. In some cases, the parameters of the aggregate attribution model are updated using feature extraction. In fine-tuning, some or all of a pre-trained model's parameters are updated based on the target task's dataset.

### Content Distribution

A method for data processing is described with reference to FIG. 8. One or more aspects of the method include obtaining individual-level user interaction data for a user from a digital content channel; computing an individual channel contribution value based on the individual-level user interaction data; updating the individual channel contribution value based on an aggregate attribution model to obtain an updated channel contribution value; and providing customized content to the user via the digital content channel based on the updated channel contribution value. In some aspects, the updated individual channel contribution value indicates a contribution of the digital content channel to an event of the individual-level user interaction data.

Some examples of the method further include computing an aggregate channel contribution value, wherein the individual channel contribution value is updated based on the aggregate channel contribution value. Some examples of the method further include generating a content distribution campaign based on the updated individual channel contribution value.

Some examples of the method further include computing a plurality of individual channel contribution values for an interaction path, wherein the plurality of individual channel contribution values corresponds to a plurality of channels, respectively. Some examples further include computing a plurality of aggregate channel contribution values corresponding to the plurality of channels, respectively. Some examples further include updating each of the plurality of individual channel contribution values based on the plurality of aggregate channel contribution values.

Some examples of the method further include training the aggregate attribution model using the individual channel contribution value and experimental testing data. Some examples of the method further include generating an attribution prior based on the individual channel contribution value. Some examples further include computing an objective function for the aggregate attribution model based on the attribution prior. Some examples further include updating parameters of the aggregate attribution model based on the objective function.

FIG. 8 shows an example of a method 800 for providing customized content according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system obtains individual-level user interaction data for a user from a digital content channel. In some cases, the operations of this step refer to, or are performed by, a multi-touch attribution model as described with reference to FIGS. 2 and 6. In some cases, the system obtains the individual-level user interaction data as described with reference to FIG. 5.

At operation 810, the system computes an individual channel contribution value based on the individual-level user interaction data. In some cases, the operations of this step refer to, or are performed by, a multi-touch attribution model as described with reference to FIGS. 2 and 6. In some cases, the system computes the individual channel contribution value as described with reference to FIG. 5. In some cases, the system trains the multi-touch attribution model as described with reference to FIG. 5.

At operation 815, the system updates the individual channel contribution value based on an aggregate attribution model to obtain an updated channel contribution value. In some cases, the operations of this step refer to, or are performed by, a calibration component as described with reference to FIG. 2. In some cases, for example, the system normalizes the individual channel contribution value as described with reference to FIG. 5.

At operation 820, the system provides customized content to the user via the digital content channel based on the updated channel contribution value. In some cases, the operations of this step refer to, or are performed by, a content component as described with reference to FIG. 2. In some cases, the system provides content based on the updated individual channel contribution value as described with reference to FIG. 5.

The description and drawings described herein represent example configurations and do not represent all the implementations within the scope of the claims. For example, the operations and steps are capable of being rearranged, combined, or otherwise modified. Also, in some cases, structures and devices are represented in the form of block diagrams to represent the relationship between components and avoid obscuring the described concepts. In some cases, similar components or features have the same name but have different reference numbers corresponding to different figures.

Some modifications to the disclosure are readily apparent to those skilled in the art, and the principles defined herein are applicable to other variations without departing from the scope of the disclosure. Thus, the disclosure is not limited to the examples and designs described herein, but is to be accorded the broadest scope consistent with the principles and novel features disclosed herein.

In some cases, the described methods are implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. In some cases, a general-purpose processor is a microprocessor, a conventional processor, controller, microcontroller, or state machine. In some cases, a processor is also implemented as a combination of computing devices (e.g., a combination of a DSP and a microprocessor, multiple microprocessors, one or more microprocessors in conjunction with a DSP core, or any other such configuration). Thus, in some cases, the functions described herein are implemented in hardware or software and are executed by a processor, firmware, or any combination thereof. In some cases, if implemented in software executed by a processor, the functions are stored in the form of instructions or code on a computer-readable medium.

Computer-readable media includes both non-transitory computer storage media and communication media including any medium that facilitates transfer of code or data. In some cases, a non-transitory storage medium is any available medium that is accessible by a computer. For example, in some cases, non-transitory computer-readable media comprises random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, in some cases, connecting components are properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” is based on condition A, condition B, or any combination thereof. In other words, the phrase “based on” shall be construed to mean “based at least in part on.” Also, the words “a” or “an” indicate “at least one.”

What is claimed is:

1. A method of training a machine learning model, comprising:
obtaining, by a multi-touch attribution model, individual-level user interaction data from a digital content channel;
computing, using the multi-touch attribution model, channel contribution data based on the individual-level user interaction data;
training, using a training component, an aggregate attribution model based on the channel contribution data; and
generating, using a calibration component, an individual channel contribution value for the digital content channel based on the channel contribution data and the aggregate attribution model.

2. The method of claim 1, wherein:
the individual channel contribution value indicates a contribution of the digital content channel to an event of the individual-level user interaction data.

3. The method of claim 1, further comprising:
computing a preliminary individual channel contribution value for the digital content channel using the multi-touch attribution model; and
computing an aggregate channel contribution value for the digital content channel using the aggregate attribution model, wherein the individual channel contribution value is generated based on the preliminary individual channel contribution value and the aggregate channel contribution value.

4. The method of claim 1, wherein:
the aggregate attribution model is trained using the channel contribution data and experimental testing data.

5. The method of claim 1, further comprising:
generating, using the training component, an attribution prior based on the channel contribution data;
computing, using the training component, an objective function for the aggregate attribution model based on the attribution prior; and
updating, using the training component, parameters of the aggregate attribution model based on the objective function.

6. The method of claim 1, further comprising:
normalizing, using the calibration component, the individual channel contribution value based on a plurality of individual channel contribution values corresponding to a plurality of content channels.

7. The method of claim 1, further comprising:
computing, using the multi-touch attribution model, the channel contribution data for an interaction path, wherein the channel contribution data corresponds to a plurality of channels, respectively;
computing, using the aggregate attribution model, a plurality of aggregate channel contribution values corresponding to the plurality of channels, respectively; and
generating, using the calibration component, a plurality of individual channel contribution values based on the plurality of aggregate channel contribution values.

8. The method of claim 1, further comprising:
providing, using a content component, content to a user via the digital content channel based on the individual channel contribution value.

9. The method of claim 1, further comprising:
generating, using a campaign component, a content distribution campaign based on the individual channel contribution value.

10. A method for data processing, comprising:
obtaining, by a multi-touch attribution model, individual-level user interaction data for a user from a digital content channel;
computing, using the multi-touch attribution model, an individual channel contribution value based on the individual-level user interaction data;
updating, using a calibration component, the individual channel contribution value based on an aggregate attribution model to obtain an updated channel contribution value; and
providing, using a content component, customized content to the user via the digital content channel based on the updated channel contribution value.

11. The method of claim 10, wherein:
the updated individual channel contribution value indicates a contribution of the digital content channel to an event of the individual-level user interaction data.

12. The method of claim 10, further comprising:
computing an aggregate channel contribution value using the aggregate attribution model, wherein the individual channel contribution value is updated based on the aggregate channel contribution value.

13. The method of claim 10, further comprising:
computing, using the multi-touch attribution model, a plurality of individual channel contribution values for an interaction path, wherein the plurality of individual channel contribution values corresponds to a plurality of channels, respectively;
computing, using the aggregate attribution model, a plurality of aggregate channel contribution values corresponding to the plurality of channels, respectively; and
updating, using the calibration component, each of the plurality of individual channel contribution values based on the plurality of aggregate channel contribution values.

14. The method of claim 10, further comprising:
training, using a training component, the aggregate attribution model using the individual channel contribution value and experimental testing data.

15. The method of claim 10, further comprising:
generating, using a training component, an attribution prior based on the individual channel contribution value;
computing, using the training component, an objective function for the aggregate attribution model based on the attribution prior; and
updating, using the training component, parameters of the aggregate attribution model based on the objective function.

16. The method of claim 10, further comprising:
generating, using a campaign component, a content distribution campaign based on the updated individual channel contribution value.

17. An apparatus for data processing, comprising:
at least one memory;
at least one processor executing instructions stored in the at least one memory;
a multi-touch attribution model comprising multi-touch attribution parameters stored in the at least one memory, the multi-touch attribution model trained to compute channel contribution data based on individual-level user interaction data from a digital content channel;
an aggregate attribution model comprising aggregate attribution parameters stored in the at least one memory, the aggregate attribution model trained to compute an aggregate channel contribution value for the digital content channel; and
a calibration component configured to generate an individual channel contribution value for the digital content channel based on the channel contribution data and the aggregate channel contribution value.

18. The apparatus of claim 17, further comprising:
a content component configured to provide content to a user via the digital content channel based on the individual channel contribution value.

19. The apparatus of claim 17, further comprising:
a campaign component configured to generate a content distribution campaign based on the individual channel contribution value.

20. The apparatus of claim 17, further comprising:
a training component configured to update parameters of the aggregate attribution model based on the channel contribution data.
